(19) United States
(12) Patent Application Publication
(10) Pub. No.: US 2020/0041834 A1
(43) Pub. Date: Feb. 6, 2020

(54) DISPLAY PANEL

(71) Applicant: SAKAI DISPLAY PRODUCTS CORPORATION, Osaka (JP)

(72) Inventors: DAISUKE TERAGAWA, Osaka (JP); TOMOHIRO ASAMIZU, Osaka (JP)

(21) Appl. No.: 16/505,546

(22) Filed: Jul. 8, 2019

(30) Foreign Application Priority Data
Aug. 3, 2018 (JP) 2018-146954

(51) Int. Cl. G02F 1/1335; G02F 1/1343

(52) U.S. Cl. CPC G02F 1/133514; G02F 1/133512; G02F 1/134309

(57) ABSTRACT

A display panel according to an embodiment of the present invention is a display panel which has a display region including a plurality of pixels arrayed along a first direction and along a second direction which is different from the first direction, the display panel including a first substrate and a second substrate opposing each other, the first substrate and the second substrate are curved along the first direction. The display region includes a central portion including a center of the display region along the first direction and, on both sides of the central portion along the first direction, two end portions that are located adjacent to the central portion. The first substrate includes a plurality of pixel electrodes provided respectively corresponding to the plurality of pixels. The second substrate has a color filter layer that includes: a plurality of color filters provided respectively corresponding to the plurality of pixels; and a black matrix. Among the plurality of color filters, each of a plurality of central color filters contained in the central portion includes a chromatic portion presenting a chromatic color. Among the plurality of color filters, a plurality of end color filters contained in the two end portions include an end color filter that includes a chromatic portion and a white portion presenting white, the white portion being disposed adjacent to the chromatic portion along the first direction.

### BACKGROUND

### 1. Technical Field

The present invention relates to a display panel that includes a first substrate having a plurality of pixel electrodes, and a second substrate opposing the first substrate and having color filters corresponding to the respective pixel electrodes, where the first substrate and the second substrate are curved.

### 2. Description of the Related Art

In recent years, so-called curved displays have been gaining popularity, in which a pair of substrates opposing each other are curved so as to constitute a curved display surface.

However, since one substrate and the other substrate of such a curved display are opposed to each other while being curved, a varying radius of curvature exists because of the interspace into which liquid crystal is to be injected (i.e., thickness of the liquid crystal layer) and the thicknesses of the substrates. The varying radius of curvature induces a problem in that, as viewed from a radial direction, the positions of pixel electrodes in one substrate and the positions of color filters in the other substrate may not match but be misaligned near both ends along the circumferential direction, while they may match in a central portion along the peripheral direction (circumferential direction) of the curved surface, for example.

Against such a problem, for example, Patent Document 1 (Japanese Laid-Open Patent Publication No. 2007-333818) discloses a display panel in which a pitch along the curving direction of pixel regions of a substrate that is on the inner side of the curve is at least locally smaller than a pitch along the curving direction of pixel regions of a substrate that is on the outer side of the curve, thereby reducing misalignments in the pixel regions between the substrates as compared to the case where an identical pitch (along the curving direction) is adopted for the pixel regions of both substrates.

### SUMMARY

On the other hand, if the aforementioned misalignments do occur, light which has passed through a pixel region that is associated with a pixel electrode may enter astride its two adjacent color filters. This leads to a problem in that, rather than a single color of R, G, B, etc., as desired, an intermixed color resulting from the colors of adjacent color filters may be displayed.

However, the display panel of Patent Document 1 may be able to reduce misalignments in the pixel regions, but it cannot adequately prevent intermixing of colors associated with misalignments. Moreover, in the display panel of Patent Document 1, the amount of misalignments in the pixel regions needs to be anticipated in advance in order for the invention to be applied, and thus any misalignments beyond anticipation cannot be coped with.

The present invention has been made in view of the above circumstances, and an objective thereof is to provide a display panel that includes a first substrate having a plurality of pixel electrodes, and a second substrate opposing the first substrate and having color filters corresponding to the respective pixel electrodes, where the first substrate and the second substrate are curved, such that the aforementioned problem of intermixing of colors can be suppressed, this effect of suppressing the problematic intermixing of colors being stably obtained.

A display panel according to an embodiment of the present invention is a display panel having a display region including a plurality of pixels arrayed along a first direction and along a second direction which is different from the first direction, the display panel comprising a first substrate and a second substrate opposing each other, the first substrate and the second substrate being curved along the first direction, wherein, the display region includes a central portion including a center of the display region along the first direction and, on both sides of the central portion along the first direction, two end portions that are located adjacent to the central portion; the first substrate includes a plurality of pixel electrodes provided respectively corresponding to the plurality of pixels; the second substrate has a color filter layer that includes: a plurality of color filters provided respectively corresponding to the plurality of pixels; and a black matrix; among the plurality of color filters, each of a plurality of central color filters contained in the central portion includes a chromatic portion presenting a chromatic color; and, among the plurality of color filters, a plurality of end color filters contained in the two end portions include an end color filter that includes a chromatic portion and a white portion presenting white, the white portion being disposed adjacent to the chromatic portion along the first direction.

According to an embodiment of the present invention, in a display panel in which the first substrate and the second substrate are curved, the aforementioned problem of intermixing of colors can be suppressed. Moreover, the effect of suppressing the problematic intermixing of colors can be stably obtained.

### BRIEF DESCRIPTION OF THE DRAWINGS

FIG. 1 is a diagram schematically showing a main configuration of a liquid crystal panel according to Embodiment 1.

FIG. 2A is an enlarged view in which a portion corresponding to a broken-lined circle A in FIG. 1 is shown enlarged.

FIG. 2B is enlarged view in which a portion corresponding to a broken-lined circle B in FIG. 1 is shown enlarged.

FIG. 2C is an enlarged view in which a portion corresponding to a broken-lined circle F in FIG. 1 is shown enlarged.

FIG. 3A is an enlarged view, regarding a liquid crystal panel according to Embodiment 2, in which a portion corresponding to a broken-lined circle A in FIG. 1 is shown enlarged.

FIG. 3B is an enlarged view, regarding the liquid crystal panel according to Embodiment 2, in which a portion corresponding to a broken-lined circle B in FIG. 1 is shown enlarged.

FIG. 3C is an enlarged view, regarding the liquid crystal panel according to Embodiment 2, in which a portion corresponding to a broken-lined circle F in FIG. 1 is shown enlarged.

FIG. 4A is an enlarged view, regarding a liquid crystal panel according to Embodiment 3, in which a portion corresponding to a broken-lined circle A in FIG. 1 is shown enlarged.

FIG. 4B is an enlarged view, regarding the liquid crystal panel according to Embodiment 3, in which a portion corresponding to a broken-lined circle D in FIG. 1 is shown enlarged.

FIG. 4C is an enlarged view, regarding the liquid crystal panel according to Embodiment 3, in which a portion corresponding to a broken-lined circle B in FIG. 1 is shown enlarged.

FIG. 5A is an enlarged view, regarding a liquid crystal panel according to Embodiment 4, in which a portion corresponding to a broken-lined circle A in FIG. 1 is shown enlarged.

FIG. 5B is an enlarged view, regarding the liquid crystal panel according to Embodiment 4, in which a portion corresponding to a broken-lined circle B in FIG. 1 is shown enlarged.

FIG. 5C is an enlarged view, regarding the liquid crystal panel according to Embodiment 4, in which a portion corresponding to a broken-lined circle F in FIG. 1 is shown enlarged.

FIG. 6A is an enlarged view, regarding a liquid crystal panel according to Embodiment 5, in which a portion corresponding to a broken-lined circle A in FIG. 1 is shown enlarged.

FIG. 6B is an enlarged view, regarding the liquid crystal panel according to Embodiment 5, in which a portion corresponding to a broken-lined circle B in FIG. 1 is shown enlarged.

FIG. 6C is an enlarged view, regarding the liquid crystal panel according to Embodiment 5, in which a portion corresponding to a broken-lined circle F in FIG. 1 is shown enlarged.

FIG. 7A is an enlarged view, regarding a liquid crystal panel according to Embodiment 6, in which a portion corresponding to a broken-lined circle A in FIG. 1 is shown enlarged.

FIG. 7B is an enlarged view, regarding the liquid crystal panel according to Embodiment 6, in which a portion corresponding to a broken-lined circle D in FIG. 1 is shown enlarged.

FIG. 7C is an enlarged view, regarding the liquid crystal panel according to Embodiment 6, in which a portion corresponding to a broken-lined circle B in FIG. 1 is shown enlarged.

FIG. 8 is a diagram schematically showing a main configuration of a liquid crystal panel according to Embodiment 7.

### DETAILED DESCRIPTION

Hereinafter, on the basis of the drawings, display panels according to embodiments of the present invention will be described in detail, with reference to a so-called liquid crystal panel.

### Embodiment 1

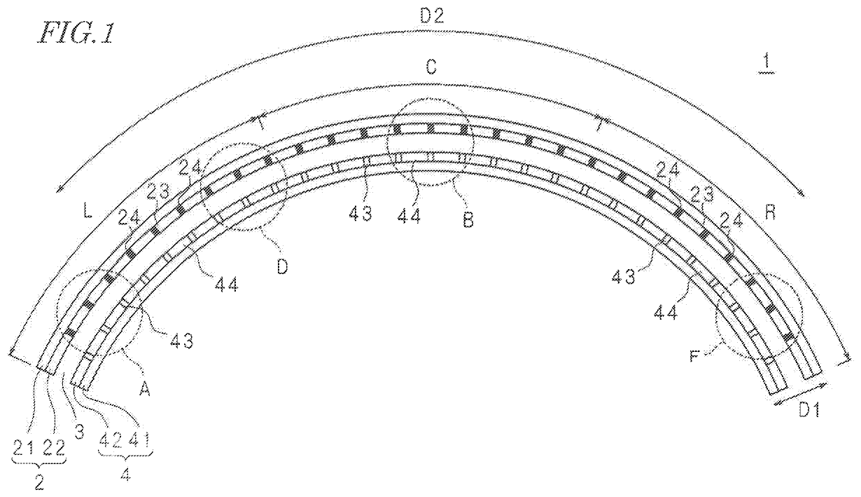

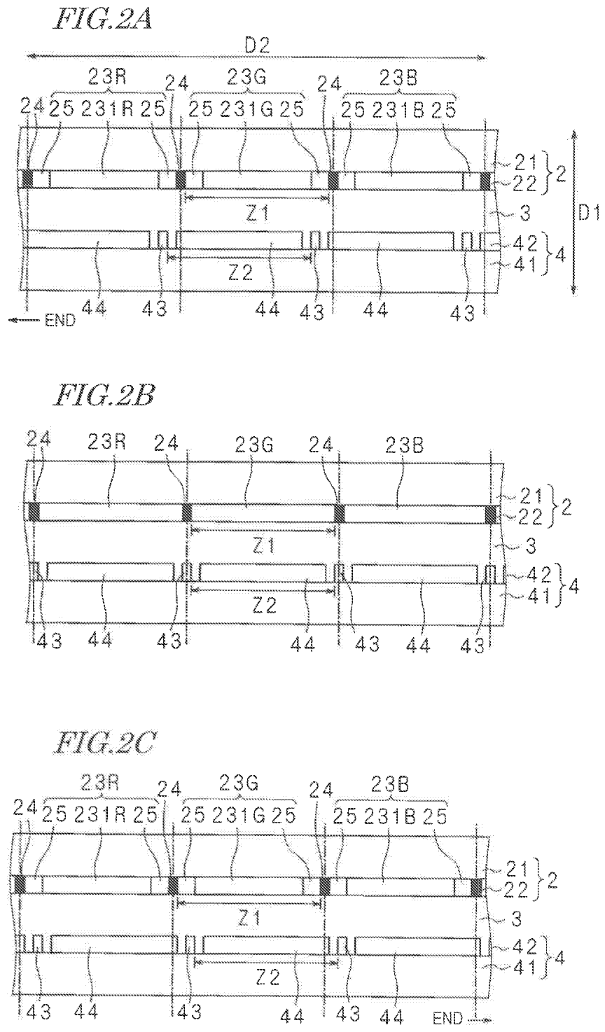

FIG. 1 is a diagram schematically showing a main configuration of a liquid crystal panel 1 according to Embodiment 1. FIG. 2A, FIG. 2B, and FIG. 2C are enlarged views in which portions corresponding to three broken-lined circles in FIG. 1 are shown enlarged. FIG. 2A is an enlarged view of a portion of the liquid crystal panel 1 in FIG. 1 corresponding to a broken-lined circle A on the left side of the figure. FIG. 2B is an enlarged view of a portion of the liquid crystal panel 1 in FIG. 1 corresponding to a broken-lined circle B at the central portion of the figure. FIG. 2C is an enlarged view of a portion of the liquid crystal panel 1 in FIG. 1 corresponding to a broken-lined circle F on the right side of the figure.

The liquid crystal panel 1 has a display region including a plurality of pixels arrayed along a first direction and along a second direction which is different from the first direction. Typically, the second direction is a direction that is substantially orthogonal to the first direction. The liquid crystal panel 1 includes an active matrix substrate (first substrate) 4 and a CF substrate (second substrate) 2 opposing each other. The active matrix substrate 4 and the CF substrate 2 are curved along the first direction. FIG. 1 shows a cross section of the liquid crystal panel 1 along the first direction. The display region of the liquid crystal panel 1 includes a central portion C including the center of the display region along the first direction and, on both sides of the central portion C along the first direction, two end portions (excess portions) L and R that are located adjacent to the central portion C. The active matrix substrate 4 includes a plurality of pixel electrodes 44 provided respectively corresponding to the plurality of pixels. The CF substrate 2 has a color filter layer 22 including a plurality of color filters 23 (23R, 23G, 23B) provided respectively corresponding to the plurality of pixels and a black matrix 24. Among the plurality of color filters 23, each of a plurality of central color filters 23 contained in the central portion C includes a chromatic portion presenting a chromatic color. Among the plurality of color filters 23, a plurality of end color filters 23 contained in the two end portions L and R include an end color filter 23 that includes a chromatic portion (colored portion) 231R, 231G, or 231B and a white portion(s) presenting white (achromatic portion(s)) 25, the white portion(s) 25 being disposed adjacent to the chromatic portion 231R, 231G, or 231B along the first direction.

The liquid crystal panel 1 includes the active matrix substrate 4 and the CF (color filter) substrate 2 which is opposed to the active matrix substrate 4. A liquid crystal layer 3 is interposed between the active matrix substrate 4 and the CF substrate 2.

The liquid crystal panel 1 is rectangular, and is curved with a predetermined curvature so as to be, for example, convex toward the CF substrate 2 (i.e., the CF substrate 2 is disposed on the outer side of the convex surface of the liquid crystal panel 1 and that the active matrix substrate 4 is disposed on the inner side of the convex surface). Specifically, the active matrix substrate 4 and the CF substrate 2 are curved with similar curvatures. Regarding the radial direction D1, the liquid crystal panel 1 has the active matrix substrate 4 disposed on the inner side and the CF substrate 2 disposed on the outer side.

The CF substrate 2 includes a glass substrate 21 and the color filter layer 22 being provided on the inner surface of the glass substrate 21 that is closer to the active matrix substrate 4. Regarding the radial direction D1, the glass substrate 21 is disposed on the outer side, whereas the color filter layer 22 is disposed on the inner side. Stated otherwise, the CF substrate 2 is curved so as to be convex toward the glass substrate 21.

The glass substrate 21 is shaped as a transparent rectangular plate. On the inner surface of the glass substrate 21, color filters 23R for the R pixels, color filters 23G for the G pixels, and color filters 23B for the B pixels, as described below, are provided in a matrix shape. Hereinafter, for convenience of explanation, the color filters 23R, the color filters 23G, and the color filters 23B may also be referred to as the color filters 23.

Specifically, along the longitudinal direction (first direction) of the glass substrate 21, the color filters 23R, the color filters 23G, and the color filters 23B alternate in this order. In other words, since the glass substrate 21 (liquid crystal panel 1) is curved along its longitudinal direction (first direction), the color filters 23R, the color filters 23G, and the color filters 23B alternate in this order along the peripheral direction (e.g., the circumferential direction) D2 of the curved surface of the liquid crystal panel 1. The color filters 23R, the color filters 23G, and the color filters 23B may present stripes extending along the second direction, for example.

On the inner surface of the glass substrate 21, the black matrix (hereinafter referred to as BM) 24 is provided in a lattice shape. In other words, on the inner surface of the glass substrate 21, along the longitudinal direction and the transverse direction of the glass substrate 21, the BM 24 is provided between the color filters 23R, the color filters 23G, and the color filters 23B. Between the color filters 23 and the liquid crystal layer 3, a transparent electrode (not shown) is provided. In other words, the CF substrate 2 has a counter electrode opposing the pixel electrodes. Since the counter electrode is provided in common for all of the pixels, it may also be referred to as a common electrode. Depending on the display mode, the common electrode may be provided in the active matrix substrate 4 rather than in the CF substrate 2.

The active matrix substrate 4 includes a glass substrate 41 and an electrode layer 42 that is provided on the inner surface of the glass substrate 41 that is closer to the CF substrate 2. Regarding the radial direction D1, the electrode layer 42 is disposed on the outer side, and the glass substrate 41 is disposed on the inner side. In other words, the active matrix substrate 4 is curved so as to be convex toward the electrode layer 42.

The glass substrate 41 is shaped as a transparent rectangular plate, with the electrode layer 42 being formed on the inner surface of the glass substrate 41. In the electrode layer 42, wiring lines 43 (signal lines and scanning lines) are formed in a lattice shape. Specifically, in the electrode layer 42, a plurality of signal lines (not shown) and scanning lines (not shown) are disposed so as to intersect one another, with the pixel electrodes 44 being provided so as to overlap a region that is surrounded by the signal lines and the scanning lines. In other words, the wiring lines 43 are formed in a lattice shape, and the pixel electrodes 44 are arranged in a matrix shape.

To the scanning lines, scanning signals are supplied from a scanning driving circuit by a line sequential method. To the signal lines, a display signal to be supplied to each pixel electrode 44 is supplied from a signal driving circuit. Based on the signal that is supplied to the pixel electrode 44 from the signal line, as a voltage is applied across the liquid crystal layer 3 between a pixel electrode 44 and the transparent electrode (common electrode) on the CF substrate 2, the luminance (grayscale level) to be presented by that pixel is attained.

For example, in the normally black mode, when no voltage is applied between a pixel electrode 44 and the transparent electrode (common electrode) of the CF substrate 2, the lowest grayscale level (black displaying state) is presented. When a maximum voltage is applied between a pixel electrode 44 and the transparent electrode of the CF substrate 2, the highest grayscale level (white displaying state) is presented. It will be appreciated that the liquid crystal panel according to the present embodiment may also adopt a normally white mode.

When the CF substrate 2 and the active matrix substrate 4 as such are opposed to each other in a planar form, i.e., without being curved, the positions of the color filters 23 of the CF substrate 2 and the positions of the pixel electrodes 44 of the active matrix substrate 4 will substantially match as viewed along the opposing direction. Such a state will uniformly exist across the entire liquid crystal panel.

However, when the CF substrate 2 and the active matrix substrate 4 are opposed to each other while being curved, a varying radius of curvature will exist because of the thicknesses of the substrates and the thickness of the liquid crystal layer 3 (i.e., the interspace into which liquid crystal is to be injected). The varying radius of curvature induces a problem in that the positions of the pixel electrodes 44 and the color filters 23 as viewed along the opposing direction may not match but be misaligned near both ends of the liquid crystal panel 1, while they may match in a central portion of the liquid crystal panel 1 along the circumferential direction D2, for example.

Hereinafter, in the liquid crystal panel 1 (the CF substrate 2, the active matrix substrate 4), any portion excluding the central portion along the circumferential direction D2 may also be referred to as an excess portion. Herein, the central portion of the liquid crystal panel 1 (the CF substrate 2, the active matrix substrate 4) along the circumferential direction D2 may be, for example, when the liquid crystal panel 1 is equally divided into three portions along the circumferential direction D2, the portion in the middle along the circumferential direction D2. That is, in FIG. 1, the central portion of the liquid crystal panel 1 (the CF substrate 2, the active matrix substrate 4) corresponds to C (hereinafter referred to as the central portion C), whereas a portion that combines a portion L on the left side of the figure and a portion R on the right side of the figure with respect to the central portion C is the excess portion (hereinafter referred to as the excess portion LR). Although the example shown illustrates the central portion C to be an approximately ⅓ region of the liquid crystal panel 1, the present embodiment is not limited thereto. The central portion of the display region may span any range, so long as the center of the display region along the first direction is included.

In the following, in the color filter layer 22 of the CF substrate 2, regions occupied by the respective color filters 23, i.e., the regions that are surrounded by the BM 24, are referred to as color filter regions Z1. In the electrode layer 42, the regions containing the pixel electrodes 44, as defined by the wiring lines 43 (signal lines and scanning lines), are referred to as pixel electrode regions Z2. With reference to FIG. 2A, FIG. 2B, and FIG. 2C, the aforementioned problem will be described in detail.

As shown in FIG. 2B, in the central portion C, a color filter region Z1 and a pixel electrode region Z2 are orthogonally opposed, such that, as viewed from the radial direction D1, the BM 24 and the wiring lines 43 match in position.

However, as shown in FIG. 2A and FIG. 2C, in the excess portion LR, a color filter region Z1 and a pixel electrode region Z2 are not orthogonally opposed, and as viewed from the radial direction D1, the BM 24 and the wiring lines 43 do not match in position. In the liquid crystal panel 1, at the portion L which is on the left side of the figure with respect to the central portion C, the pixel electrode region Z2 is misaligned toward the left end along the circumferential direction D2 (see FIG. 2A). Moreover, in the liquid crystal panel 1, at the portion R which is on the right side of the figure with respect to the central portion C, the pixel electrode region Z2 is misaligned toward the right end along the circumferential direction D2 (see FIG. 2C).

As a result, an intermixing of colors may occur in the excess portion LR because of the misalignment of the pixel electrode region Z2. That is, in the excess portion LR, if a misalignment of the pixel electrode region Z2 occurs, light which has passed through one pixel electrode region Z2 may enter astride two adjacent color filter regions Z1. As a result, rather than a single color of R, G, and B as desired, an intermixed color resulting from the colors of adjacent color filters 23 will be displayed.

However, the liquid crystal panel 1 according to the present embodiment is constructed so that such a problem of intermixing of colors can be suppressed. Hereinafter, this will be described in detail.

In the liquid crystal panel 1 according to the present embodiment, each color filter 23 in at least the excess portion LR of the CF substrate 2 includes a colored portion and achromatic portions. As shown in FIG. 2A and FIG. 2C, each color filter 23R includes a colored portion 231R of an R color and achromatic portions 25, 25 on both sides of the colored portion 231R along the circumferential direction D2. Moreover, each color filter 23G includes a colored portion 231G of a G color and achromatic portions 25, 25 on both sides of the colored portion 231G along the circumferential direction D2, and each color filter 23B includes a colored portion 231B of a B color and achromatic portions 25, 25 on both sides of the colored portion 231B along the circumferential direction D2.

Stated otherwise, in the excess portion LR, along the circumferential direction D2, achromatic portions 25, 25 are provided on both sides of each BM 24. The achromatic portions 25, 25 may be e.g. colorless, or colored in white.

With such construction, in the liquid crystal panel 1 according to the present embodiment, in the excess portion LR, intermixing of colors is suppressed even if misalignments in the pixel electrode regions Z2 occur in the aforementioned manner. Hereinafter, for convenience of explanation, regarding the L portion in the excess portion LR, a color filter 23G will be taken for example with reference to FIG. 2A.

A pixel electrode region Z2 that needs to be orthogonally opposed to a color filter 23G may suffer a misalignment toward the left side of the figure as viewed from the radial direction D1, whereby a portion of the pixel electrode region Z2 may become opposed also to a portion of the color filter 23R. However, in the liquid crystal panel 1 according to the present embodiment, as described above, achromatic portions 25, 25 are provided on both sides of each of the colored portions 231R, 231G and 231B, so that the aforementioned portion of the pixel electrode region Z2 will be opposed to the achromatic portion 25 of the color filter 23R along the radial direction D1. Therefore, even if light which has passed through the pixel electrode region Z2 enters astride the color filter 23G and the color filter 23R, the light which has passed through the achromatic portions 25, 25 does not exhibit any color, and thus no intermixing of colors occurs concerning the G color.

Regarding the R portion of the excess portion LR, a color filter 23G will be taken for example with reference to FIG. 2C.

A pixel electrode region Z2 that needs to be orthogonally opposed to a color filter 23G may suffer a misalignment toward the right side of the figure as viewed from the radial direction D1, whereby a portion of the pixel electrode region Z2 may become opposed also to a portion of the color filter 23B. However, in the liquid crystal panel 1 according to the present embodiment, as described above, achromatic portions 25, 25 are provided on both sides of the colored portions 231R, 231G and 231B, so that the aforementioned portion of the pixel electrode region Z2 will be opposed to the achromatic portion 25 of the color filter 23B along the radial direction D1. Therefore, even if light which has passed through the pixel electrode region Z2 enters astride the color filter 23G and the color filters 23B, the light which has passed through the achromatic portions 25, 25 does not exhibit any color, and thus no intermixing of colors occurs concerning the G color.

On the other hand, as shown in FIG. 2B, the aforementioned misalignments in the pixel electrode regions Z2 do not occur in the central portion C, and thus the problem of intermixing of colors does not occur either.

Thus, in the liquid crystal panel 1 according to the present embodiment, achromatic portions 25, 25 are provided for each color filter 23 exclusively in the excess portion LR, which is susceptible to misalignments in the pixel electrode regions Z2, and not in the central portion C, which is immune to misalignments in the pixel electrode regions Z2. As a result, the problem of intermixing of colors can be addressed in a more efficient manner.

In the illustrated example, in each end color filter 23, the white portions 25 are disposed on both sides of the chromatic portion 231R, 231G, or 231B along the first direction; however, the present embodiment is not limited thereto. In the example shown in FIG. 1, for example, the CF substrate 2 is disposed on the outer side of the curved convex surface of the liquid crystal panel 1, whereas the active matrix substrate 4 is disposed on the inner side of the convex surface. In this case, as shown in FIG. 2A, FIG. 2B, and FIG. 2C, the active matrix substrate 4 is misaligned with respect to the CF substrate 2, toward an end in the first direction. In the end portion L shown in FIG. 2A, the active matrix substrate 4 is misaligned with respect to the CF substrate 2, toward the left end of the liquid crystal panel 1 (toward the left in the figure); and, in the end portion R shown in FIG. 2C, the active matrix substrate 4 is misaligned with respect to the CF substrate 2 toward the right end of the liquid crystal panel 1 (toward the right in the figure). In order to prevent intermixing of colors ascribable to such misalignments, in each end color filter 23 in the end portion L shown in FIG. 2A, a white portion 25 may be provided at least on the right side of the chromatic portion 231R, 231G, or 231B, and in each end color filter 23 in the end portion R shown in FIG. 2C, a white portion 25 may be provided at least on the left side of the chromatic portion 231R, 231G, or 231B. In other words, regarding each pixel, among directions that are parallel to the first direction, a third direction may be defined as a direction from that pixel toward the center of the display region along the first direction; then, it is preferable that the plurality of end color filters include an end color filter that includes a chromatic portion and a white portion, the white portion being disposed adjacent to the chromatic portion along the third direction. This similarly applies also to the following embodiments. The same may similarly be applied to the central portion C, too. The plurality of central color filters may include a central color filter that includes a chromatic portion and a white portion, the white portion being disposed adjacent to the chromatic portion along the third direction. Disposition of a white portion(s) may be arbitrarily decided for the pixel in the center of the display region along the first direction.

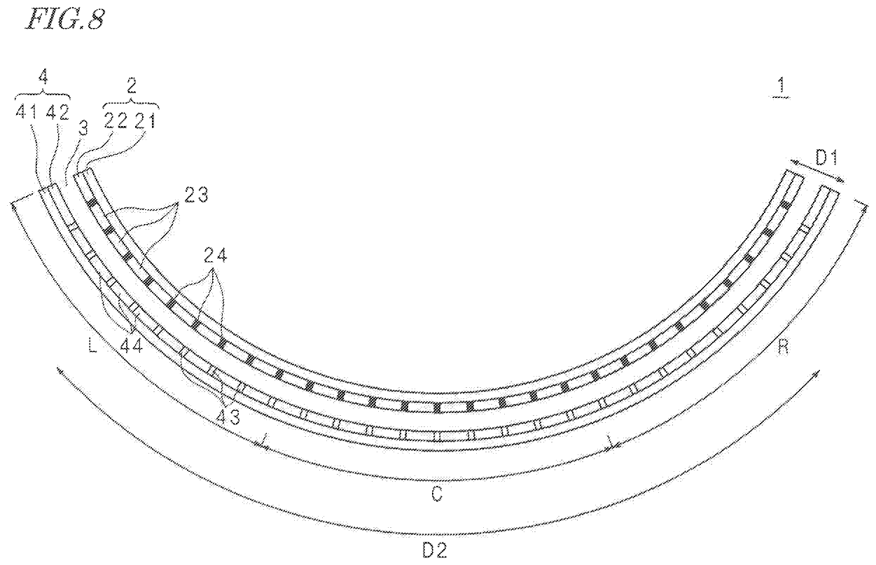

When the active matrix substrate 4 and the CF substrate 2 are reversed in position, as in the example shown in FIG. 8 which will be referred to later, misalignments will occur in reverse directions. In other words, in the case where the CF substrate 2 is disposed on the inner side of the curved convex surface of the liquid crystal panel 1 and the active matrix substrate 4 is disposed on the outer side of the convex surface, the active matrix substrate 4 will be misaligned toward the center along the first direction, with respect to the CF substrate 2. Therefore, the positions in which to provide white portions will be reversed from what is described above. Regarding each pixel, among directions that are parallel to the first direction, a fourth direction may be defined as a direction from the center of the display region along the first direction toward that pixel; then, it is preferable that the plurality of end color filters include an end color filter that includes a chromatic portion and a white portion, the white portion being disposed adjacent to the chromatic portion along the fourth direction. The plurality of central color filters may include a central color filter that includes a chromatic portion and a white portion, the white portion being disposed adjacent to the chromatic portion along the fourth direction.

Moreover, the chromatic portions of the respective color filter 23 are typically substantially uniform in terms of intensity of color, but they may not be uniform.

### Embodiment 2

In a liquid crystal panel 1 according to Embodiment 2, achromatic portions 25, 25 are provided for each color filter 23 not only in the excess portion LR but also in the central portion C. In other words, the plurality of central color filters include a central color filter that further includes a white portion(s) 25, the white portion(s) 25 being disposed adjacent to the chromatic portion along the first direction. Hereinafter, this will be described in detail.

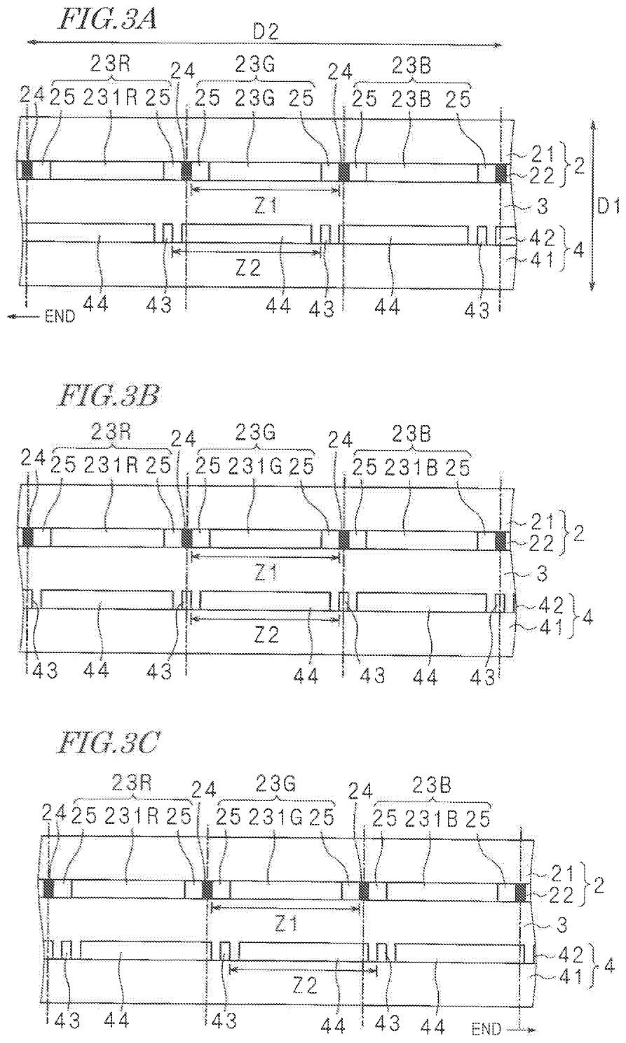

FIG. 3A, FIG. 3B, and FIG. 3C are enlarged views, regarding the liquid crystal panel 1 according to Embodiment 2, in which portions corresponding to three broken-lined circles in FIG. 1 are shown enlarged. FIG. 3A is an enlarged view of a portion of the liquid crystal panel 1 in FIG. 1 corresponding to a broken-lined circle A on the left side of the figure. FIG. 3B is an enlarged view of a portion of the liquid crystal panel 1 in FIG. 1 corresponding to a broken-lined circle B at the central portion of the figure. FIG. 3C is an enlarged view of a portion of the liquid crystal panel 1 in FIG. 1 corresponding to a broken-lined circle F on the right side of the figure.

In the liquid crystal panel 1 according to the present embodiment, each color filter 23 in the central portion C includes a colored portion and achromatic portions. As shown in FIG. 3B, each color filter 23R includes a colored portion 231R of an R color and achromatic portions 25, 25 on both sides of the colored portion 231R along the circumferential direction D2. Moreover, each color filter 23G includes a colored portion 231G of a G color and achromatic portions 25, 25 on both sides of the colored portion 231G along the circumferential direction D2, and each color filter 23B includes a colored portion 231B of a B color and achromatic portions 25, 25 on both sides of the colored portion 231B along the circumferential direction D2.

Stated otherwise, in the central portion C, along the circumferential direction D2, achromatic portions 25, 25 are provided on both sides of each BM 24. The achromatic portions 25, 25 may be e.g. colorless, or colored in white.

Otherwise, FIG. 3A and FIG. 3C are identical to FIG. 2A and FIG. 2C, and any detailed description is omitted here, as it has already been set forth in Embodiment 1.

With such construction, in the liquid crystal panel 1 according to the present embodiment, in the central portion C, intermixing of colors can be suppressed even if misalignments in the pixel electrode regions Z2 occur in the aforementioned manner. The specific action and effects have already been described in Embodiment 1, and any detailed description thereof is omitted here.

Moreover, in the liquid crystal panel 1 according to the present embodiment, as described above, achromatic portions 25, 25 are provided for each color filter 23 not only in the excess portion LR but also in the central portion C. Therefore, if the position of the active matrix substrate 4 is misaligned with respect to the CF substrate 2 due to mistakes in handling etc., during manufacture of the liquid crystal panel 1, the problem of intermixing of colors can be appropriately addressed.

Portions similar to those of Embodiment 1 are denoted by like numerals, with their detailed description omitted.

In the illustrated example, in each central color filter 23, the white portions 25 are disposed on both sides of the chromatic portion 231R, 231G, or 231B along the first direction; however, the present embodiment is not limited thereto. The plurality of central color filters 23 may include a central color filter(s) 23 in which a white portion 25 is disposed only on one side of the chromatic portion 231R, 231G, or 231B along the first direction.

### Embodiment 3

A liquid crystal panel 1 according to Embodiment 3 is constructed so that the width of the achromatic portion(s) 25 along the circumferential direction D2 (i.e., a length of the white portion 25 along the first direction) of each color filter 23 differs depending on the position in the liquid crystal panel 1 (CF substrate 2) along the circumferential direction D2. Hereinafter, this will be described in detail.

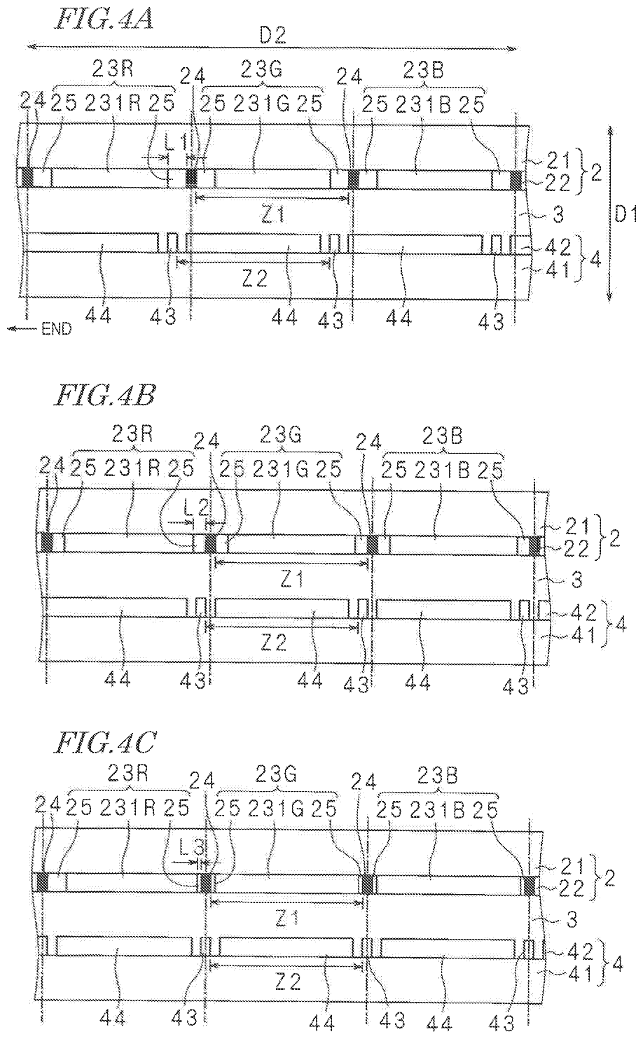

FIG. 4A, FIG. 4B, and FIG. 4C are enlarged views, regarding the liquid crystal panel 1 according to Embodiment 3, in which portions corresponding to three broken-lined circles in FIG. 1 are shown enlarged. FIG. 4A is an enlarged view of a portion of the liquid crystal panel 1 in FIG. 1 corresponding to a broken-lined circle A on the left side of the figure. FIG. 4B is an enlarged view of a portion of the liquid crystal panel 1 in FIG. 1 corresponding to a broken-lined circle D on the left side of the figure. FIG. 4C is an enlarged view of a portion of the liquid crystal panel 1 in FIG. 1 corresponding to a broken-lined circle B at the central portion of the figure.

That is, FIG. 4A, FIG. 4B, and FIG. 4C show, along the circumferential direction D2, portions from the center to the left in the figure of the liquid crystal panel 1. FIG. 4C shows a central portion of the liquid crystal panel 1 along the circumferential direction D2; FIG. 4A shows a left end portion in the figure of the liquid crystal panel 1 along the circumferential direction D2; and FIG. 4B shows a portion which is on the left side of the central portion in the figure of the liquid crystal panel 1 along the circumferential direction D2, but which is closer to the center than is the left end in the figure.

As can be seen from FIG. 4A and FIG. 4B, pixel electrode regions Z2 are misaligned toward the left end in the figure of the liquid crystal panel 1 along the circumferential direction D2. Also, it can be seen that, along the circumferential direction D2, the pixel electrode regions Z2 are misaligned to a greater extent as getting closer to the left end in the figure of the liquid crystal panel 1, that is, away from the center.

Accordingly, the liquid crystal panel 1 according to the present embodiment is constructed so that, in each color filter 23, the width of the achromatic portion(s) 25 along the circumferential direction D2 broadens away from the center of the liquid crystal panel 1 (CF substrate 2) along the circumferential direction D2.

As shown in FIG. 1, in the liquid crystal panel 1 according to the present embodiment, the portion indicated in the broken-lined circle A corresponds to an end on the left side of the figure along the circumferential direction D2 relative to the portions indicated in the broken-lined circles D and B. In the portion indicated in the broken-lined circle A as such, along the circumferential direction D2, it is ensured that the width L1 of the achromatic portion(s) 25 (FIG. 4A) is broader than the respective widths L2 (FIG. 4B) and L3 (FIG. 4C) of the achromatic portion(s) 25 of the broken-lined circles D and B.

Moreover, in the liquid crystal panel 1 according to the present embodiment, the portion indicated in the broken-lined circle D corresponds to a portion which is closer to the center than is the portion indicated in the broken-lined circle A and which is on the left side of the figure relative to the portion indicated in the broken-lined circle B, along the circumferential direction D2. In the portion indicated in the broken-lined circle D as such, it is ensured that the width L2 of the achromatic portion(s) 25 along the circumferential direction D2 is narrower than the width L1 of the achromatic portion(s) 25 within the broken-lined circle A, but broader than the width L3 of the achromatic portion(s) 25 within the broken-lined circle B.

Moreover, in the liquid crystal panel 1 according to the present embodiment, the portion indicated in the broken-lined circle B corresponds to the central portion along the circumferential direction D2. In the portion indicated in the broken-lined circle B as such, it is ensured that the width L3 of the achromatic portion(s) 25 along the circumferential direction D2 is narrower than the respective widths L1 and L2 of the achromatic portion(s) 25 within the broken-lined circles A and D. Without being limited thereto, no achromatic portions 25 may be provided in the portion indicated in the broken-lined circle B.

With such construction, in the liquid crystal panel 1 according to the present embodiment, in the central portion C and in the excess portion LR, intermixing of colors can be suppressed even if misalignments in the pixel electrode regions Z2 occur in the aforementioned manner. The specific action and effects have already been described in Embodiment 1, and any detailed description thereof is omitted here.

Moreover, in the liquid crystal panel 1 according to the present embodiment, as described above, it is ensured that the width of the achromatic portion(s) 25 broadens away from the center of the liquid crystal panel 1 (CF substrate 2) along the circumferential direction D2, thus keeping the proportion of the achromatic portions 25 in the entire CF substrate 2 as small as possible. Therefore, by adding the achromatic portions 25 to the color filters 23, deteriorations in vividness of the displayed color can be minimized.

Moreover, the liquid crystal panel 1 according to the present embodiment is not limited to the aforementioned construction. For example, the achromatic portions 25 may be provided only in the excess portion LR, and it may only be within the bounds of the excess portion LR that the width of the achromatic portion(s) 25 broadens away from the center of the liquid crystal panel 1 (CF substrate 2).

Portions similar to those of Embodiment 1 are denoted by like numerals, with their detailed description omitted.

### Embodiment 4

In a liquid crystal panel 1 according to Embodiment 4, the colored portions 231R, 231G and 231B of the color filters 23 in the excess portion LR of the liquid crystal panel 1 (i.e., the end color filters 23) are constructed so as to have a higher saturation than conventional. Hereinafter, this will be described in detail.

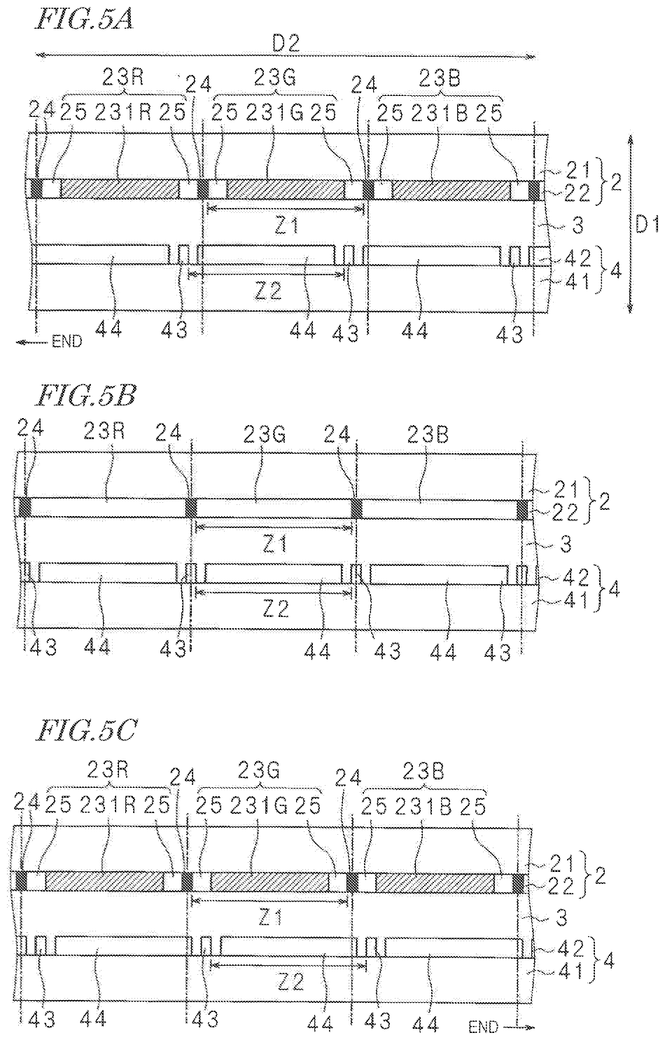

FIG. 5A, FIG. 5B, and FIG. 5C are enlarged views, regarding the liquid crystal panel 1 according to Embodiment 4, in which portions corresponding to three broken-lined circles in FIG. 1 are shown enlarged. FIG. 5A is an enlarged view of a portion of the liquid crystal panel 1 in FIG. 1 corresponding to a broken-lined circle A on the left side of the figure. FIG. 5B is an enlarged view of a portion of the liquid crystal panel 1 in FIG. 1 corresponding to a broken-lined circle B at the central portion of the figure. FIG. 5C is an enlarged view of a portion of the liquid crystal panel 1 in FIG. 1 corresponding to a broken-lined circle F on the right side of the figure.

Note that, in FIG. 5A, FIG. 5B, and FIG. 5C, places of high saturation are shown hatched.

In the liquid crystal panel 1 according to the present embodiment, similarly to Embodiment 1, each color filter 23 in the excess portion LR of the CF substrate 2 includes a colored portion and achromatic portions. In other words, in the excess portion LR, each color filter 23R includes a colored portion 231R and achromatic portions 25, 25 on both sides of the colored portion 231R along the circumferential direction D2; each color filter 23G includes a colored portion 231G and achromatic portions 25, 25 on both sides of the colored portion 231G along the circumferential direction D2; and each color filter 23B includes a colored portion 231B and achromatic portions 25, 25 on both sides of the colored portion 231B along the circumferential direction D2.

Furthermore, in the liquid crystal panel 1 according to the present embodiment, the colored portions 231R, 231G and 231B of the color filters 23 within the excess portion LR have a higher saturation than conventional.

Specifically, generally speaking, the xy color coordinates of RGB in TVs, monitors, and the like are often close to R (0.64,0.33), G (0.30,0.60), and B (0.15,0.06) of the sRGB standard. This may sometimes be said to correspond to 72% of NTSC, where the xy color coordinates under the NTSC standard are R (0.67,0.33), G (0.21,0.71), and B (0.14,0.08), through a comparison of triangle area ratio based on these coordinates.

On the other hand, in the liquid crystal panel 1 according to the present embodiment, achromatic portions 25 are provided in the color filters 23 within the excess portion LR of the CF substrate 2; this may, as if white being mixed in the color filters 23, reduce the area ratio to NTSC, thus possibly resulting in a narrower range of color reproduction.

On the other hand, in the liquid crystal panel 1 according to the present embodiment, in the color filters 23 in the excess portion LR, it is ensured that the colors of the colored portions 231R, 231G and 231B have a higher saturation than conventional. Specifically, in xy color coordinates, the color of the colored portions 231R is R (above 0.64 to 0.67, 0.32 to 0.34), the color of the colored portions 231G is G (0.21 to below 0.30, above 0.60 to 0.71), and the color of the colored portions 231B is B (0.13 to below 0.15, 0.05 to below 0.06).

With such construction, in the liquid crystal panel 1 according to the present embodiment, in the excess portion LR, intermixing of colors can be suppressed even if misalignments in the pixel electrode regions Z2 occur in the aforementioned manner. The specific action and effects have already been described in Embodiment 1, and any detailed description thereof is omitted here.

Moreover, in the liquid crystal panel 1 according to the present embodiment, as described above, the colors of the colored portions 231R, 231G and 231B of the color filters 23 within the excess portion LR have a higher saturation than conventional, and therefore the problem of narrowed ranges of color reproduction in the excess portion LR can be suppressed as aforementioned.

Portions similar to those of Embodiment 1 are denoted by like numerals, with their detailed description omitted.

### Embodiment 5

In a liquid crystal panel 1 according to Embodiment 5, the colored portions 231R, 231G and 231B of the color filters 23 in the central portion C and the excess portion LR of the liquid crystal panel 1 (i.e., the central color filters 23 and end color filters 23) are constructed so as to have a higher saturation than conventional. Hereinafter, this will be described in detail.

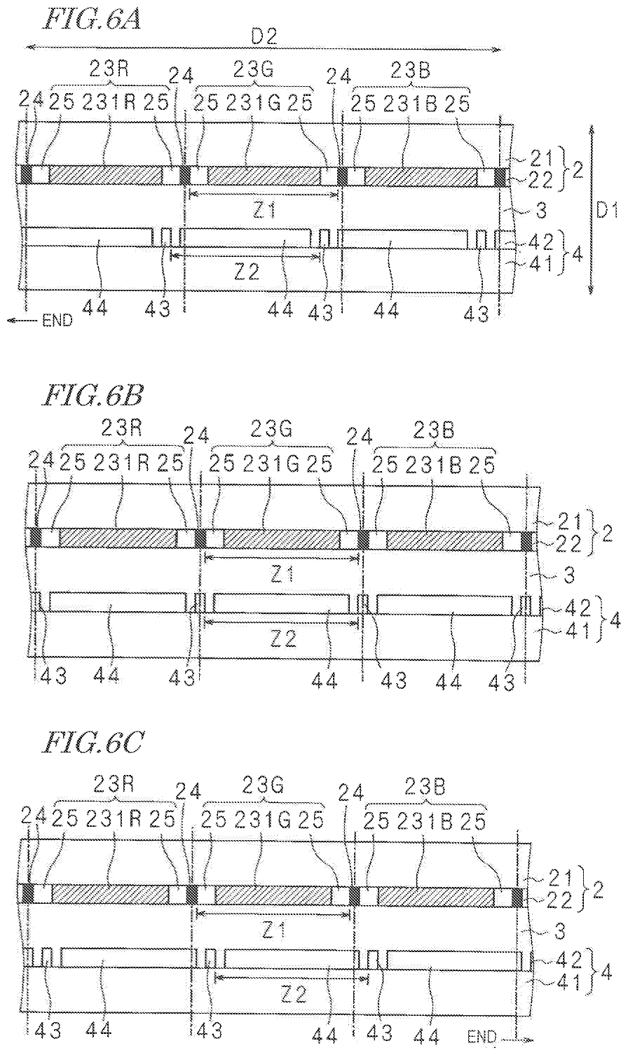

FIG. 6A, FIG. 6B, and FIG. 6C are enlarged views, regarding the liquid crystal panel 1 according to Embodiment 5, in which portions corresponding to three broken-lined circles in FIG. 1 are shown enlarged. FIG. 6A is an enlarged view of a portion of the liquid crystal panel 1 in FIG. 1 corresponding to a broken-lined circle A on the left side of the figure. FIG. 6B is an enlarged view of a portion of the liquid crystal panel 1 in FIG. 1 corresponding to a broken-lined circle B at the central portion of the figure. FIG. 6C is an enlarged view of a portion of the liquid crystal panel 1 in FIG. 1 corresponding to a broken-lined circle F on the right side of the figure.

Note that, in FIG. 6A, FIG. 6B, and FIG. 6C, places of high saturation are shown hatched.

In the liquid crystal panel 1 according to the present embodiment, similarly to Embodiment 2, each color filter 23 in the central portion C and the excess portion LR of the CF substrate 2 includes a colored portion and achromatic portions. In other words, in the central portion C and in the excess portion LR, each color filter 23R includes a colored portion 231R and achromatic portions 25, 25 on both sides of the colored portion 231R along the circumferential direction D2; each color filter 23G includes a colored portion 231G and achromatic portions 25, 25 on both sides of the colored portion 231G along the circumferential direction D2; and each color filter 23B includes a colored portion 231B and achromatic portions 25, 25 on both sides of the colored portion 231B along the circumferential direction D2.

Furthermore, in the liquid crystal panel 1 according to the present embodiment, the colored portions 231R, 231G and 231B of the color filters 23 within the central portion C and the excess portion LR have a higher saturation than conventional.

Specifically, generally speaking, the xy color coordinates of RGB in TVs, monitors, and the like are often close to R (0.64,0.33), G (0.30,0.60), and B (0.15,0.06) of the sRGB standard.

On the other hand, in the liquid crystal panel 1 according to the present embodiment, achromatic portions 25 are provided in the color filters 23 within the central portion C and the excess portion LR of the CF substrate 2; this may, as if white being mixed in the color filters 23, reduce the area ratio to NTSC, thus possibly resulting in a narrower range of color reproduction.

On the other hand, in the liquid crystal panel 1 according to the present embodiment, in the color filters 23 in the central portion C and the excess portion LR, it is ensured that the colors of the colored portions 231R, 231G and 231B have a higher saturation than conventional. Specifically, in xy color coordinates, the color of the colored portions 231R is R (0.64 to 0.67, 0.32 to 0.34), the color of the colored portions 231G is G (0.21 to 0.30, 0.60 to 0.71), and the color of the colored portions 231B is B (0.13 to 0.15, 0.05 to 0.06).

With such construction, in the liquid crystal panel 1 according to the present embodiment, in the central portion C and in the excess portion LR, intermixing of colors can be suppressed even if misalignments in the pixel electrode regions Z2 occur in the aforementioned manner. The specific action and effects have already been described in Embodiment 1, and any detailed description thereof is omitted here.

Moreover, in the liquid crystal panel 1 according to the present embodiment, as described above, the colors of the colored portions 231R, 231G and 231B of the color filters 23 within the central portion C and the excess portion LR have a higher saturation than conventional, and therefore the problem of narrowed ranges of color reproduction can be suppressed in the central portion C and in the excess portion LR as aforementioned.

Portions similar to those of Embodiments 1 and 2 are denoted by like numerals, with their detailed description omitted.

### Embodiment 6

A liquid crystal panel 1 according to Embodiment 6 is constructed so that the saturation of the color of the colored portion 231R, 231G, 231B of each color filter 23 differs depending on the position along the circumferential direction D2. Hereinafter, this will be described in detail.

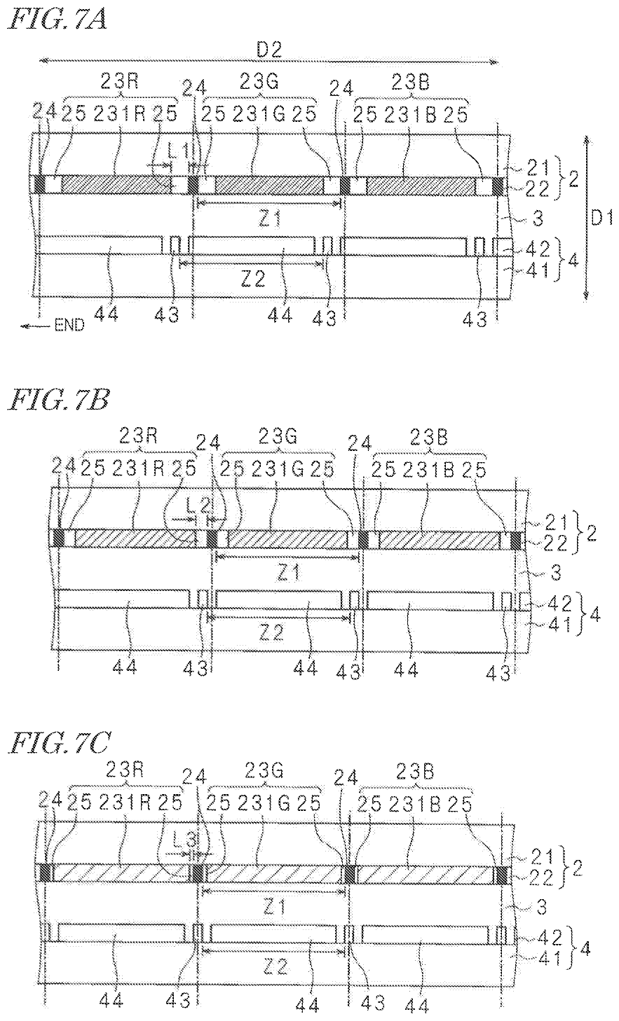

FIG. 7A, FIG. 7B, and FIG. 7C are enlarged views, regarding the liquid crystal panel 1 according to Embodiment 6, in which portions corresponding to three broken-lined circles in FIG. 1 are shown enlarged. FIG. 7A is an enlarged view of a portion of the liquid crystal panel 1 in FIG. 1 corresponding to a broken-lined circle A on the left side of the figure. FIG. 7B is an enlarged view of a portion of the liquid crystal panel 1 in FIG. 1 corresponding to a broken-lined circle D on the left side of the figure. FIG. 7C is an enlarged view of a portion of the liquid crystal panel 1 in FIG. 1 corresponding to a broken-lined circle B at the central portion of the figure.

In FIG. 7A, FIG. 7B, and FIG. 7C, different saturations of colors are indicated by the pitches between lines of hatching. A narrower pitch between lines represents a higher saturation.

In other words, FIG. 7A, FIG. 7B, and FIG. 7C show, along the circumferential direction D2, portions from the center to the left in the figure of the liquid crystal panel 1. FIG. 7C shows a central portion of the liquid crystal panel 1 along the circumferential direction D2; FIG. 7A shows a left end portion in the figure of the liquid crystal panel 1 along the circumferential direction D2; and FIG. 7B shows a portion which is on the left side of the central portion in the figure of the liquid crystal panel 1 along the circumferential direction D2, but which is closer to the center than is the left end in the figure.

In the liquid crystal panel 1 according to the present embodiment, similarly to Embodiment 2, each color filter 23 in the central portion C and the excess portion LR of the CF substrate 2 has a colored portion 231R, 231G, 231B and achromatic portions 25.

As can be seen from FIG. 7A, FIG. 7B, and FIG. 7C, the pixel electrode regions Z2 are misaligned toward the left end in the figure of the liquid crystal panel 1 along the circumferential direction D2. It can also be seen that, along the circumferential direction D2, the pixel electrode regions Z2 are misaligned to a greater extent as getting closer to the left end in the figure of the liquid crystal panel 1, i.e., away from the center.

Accordingly, the liquid crystal panel 1 according to the present embodiment is constructed so that, in each color filter 23, the width of the achromatic portion(s) 25 along the circumferential direction D2 broadens away from the center of the liquid crystal panel 1 (CF substrate 2) along the circumferential direction D2.

In other words, along the circumferential direction D2, the width L3 of the achromatic portion(s) 25 in the central portion (see the broken-lined circle B in FIG. 1) of the liquid crystal panel 1, the width L1 of the achromatic portion(s) 25 at the left end in the figure of the liquid crystal panel 1 (the broken-lined circle A in FIG. 1), and the width L2 of the achromatic portion(s) 25 in a portion which is on the left side of the central portion in the figure of the liquid crystal panel 1 but which is closer to the center than is the left end in the figure (the broken-lined circle D in FIG. 1) are of the relationship “L1>L2>L3”.

On the other hand, because of the achromatic portions 25 being provided in the color filters 23 within the central portion C and the excess portion LR of the CF substrate 2, as if white being mixed in the color filters 23, the aforementioned area ratio to NTSC may become reduced, thus possibly resulting in a narrower range of color reproduction. Furthermore, in the liquid crystal panel 1 according to the present embodiment, the width of the achromatic portion(s) 25 becomes broader away from the center of the liquid crystal panel 1 (CF substrate 2) along the circumferential direction D2, so that the amounts of reduction in the area ratio to NTSC also becomes greater away from the center of the liquid crystal panel 1 (CF substrate 2) along the circumferential direction D2.

In order to address this, in the liquid crystal panel 1 according to the present embodiment, it is ensured that the saturations of colors of the colored portions 231R, 231G and 231B of the color filters 23 within the central portion C and the excess portion LR are higher than conventional, and increase away from the center of the liquid crystal panel 1 (CF substrate 2) along the circumferential direction D2.

Specifically, generally speaking, the xy color coordinates of RGB in TVs, monitors, and the like are often close to R (0.64,0.33), G (0.30,0.60), and B (0.15,0.06) of the sRGB standard.

In the liquid crystal panel 1 according to the present embodiment, the colors of the colored portions 231R, 231G and 231B of the color filters 23 in the central portion C and the excess portion LR are such that, in xy color coordinates, the color of the colored portions 231R is within the range of R (0.64 to 0.67,0.32 to 0.34), the color of the colored portions 231G is within the range of G (0.21 to 0.30,0.60 to 0.71), and the color of the colored portions 231B is within the range of B (0.13 to 0.15,0.05 to 0.06).

Moreover, the xy color coordinates (saturation) are defined within the aforementioned ranges in such a manner that the saturations of colors of the colored portions 231R, 231G and 231B increase away from the center of the liquid crystal panel 1 (CF substrate 2) along the circumferential direction D2.

With such construction, in the liquid crystal panel 1 according to the present embodiment, in the central portion C and in the excess portion LR, intermixing of colors can be suppressed even if misalignments in the pixel electrode regions Z2 occur in the aforementioned manner. The specific action and effects have already been described in Embodiment 1, and any detailed description thereof is omitted here.

Moreover, in the liquid crystal panel 1 according to the present embodiment, as described above, it is ensured that the saturations of colors of the colored portions 231R, 231G and 231B of the color filters 23 within the central portion C and the excess portion LR are higher than conventional, and increase away from the center of the liquid crystal panel 1 (CF substrate 2) along the circumferential direction D2. Therefore, it is ensured that, while suppressing the problem of narrowed ranges of color reproduction in the central portion C and in the excess portion LR as aforementioned, colors of similar saturations are displayed in the central portion C and in the excess portion LR.

Portions similar to those of Embodiment 1 are denoted by like numerals, with their detailed description omitted.

### Embodiment 7

The above description has illustrated exemplary cases where the liquid crystal panel 1 is curved so that the CF substrate 2 is on the outer side and the active matrix substrate 4 is on the inner side regarding the radial direction D1; however, the present invention is not limited thereto.

FIG. 8 is a diagram schematically showing a main configuration of a liquid crystal panel 1 according to Embodiment 7. The liquid crystal panel 1 according to Embodiment 7 is curved so as to be convex toward the active matrix substrate 4. In other words, the liquid crystal panel 1 is curved, such that the CF substrate 2 is on the inner side and the active matrix substrate 4 is on the outer side regarding the radial direction D1. The present invention is also applicable to such a case.

In the liquid crystal panel 1 according to the present embodiment may be susceptible to a problem in that the CF substrate 2 may be misaligned. In other words, a problem may occur in that the pixel electrode region Z2 may have a relative misalignment.

That is, since the CF substrate 2 and the active matrix substrate 4 opposed to each other while being curved, a varying radius of curvature will exist because of the thickness of the substrates and the interspace into which liquid crystal is to be injected (i.e., thickness of the liquid crystal layer 3). The varying radius of curvature induces a problem in that the positions of pixel electrodes 44 and the color filters 23 as viewed along the opposing direction may not match but be misaligned near both ends of the liquid crystal panel 1, while they may match in a central portion of the liquid crystal panel 1 along the circumferential direction D2, for example.

Specifically, in the central portion C, the color filters 23 of the CF substrate 2 and the pixel electrodes 44 of the active matrix substrate 4 are orthogonally opposed, such that, as viewed from the radial direction D1, the BM 24 and the wiring lines 43 match in position.

In the excess portion LR, however, the color filters 23 and the pixel electrode 44 are not orthogonally opposed, such that the BM 24 and the wiring lines 43 do not match in position as viewed from the radial direction D1. In the liquid crystal panel 1, at the portion L which is on the left side of the figure with respect to the central portion C, the color filters 23 of the CF substrate 2 are misaligned toward the left end along the circumferential direction D2. Moreover, in the liquid crystal panel 1, at the portion R which is on the right side of the figure with respect to the central portion C, the color filters 23 of the CF substrate 2 are misaligned toward the right end along the circumferential direction D2.

On the other hand, in the liquid crystal panel 1 of Embodiments 1 to 6, the pixel electrode 44 of the active matrix substrate 4 is misaligned toward the left end along the circumferential direction D2 (see FIG. 2A) in the portion L on the left side of the figure with respect to the central portion C, and is misaligned toward the right end along the circumferential direction D2 (see FIG. 2C) in the portion R on the right side of the figure with respect to the central portion C. In this aspect, the liquid crystal panel 1 according to the present embodiment differs from Embodiments 1 to 6.

The liquid crystal panels 1 according to Embodiments 1 to 6 which are curved so as to be convex toward the CF substrate 2 and the liquid crystal panel 1 according to the present embodiment which is curved so as to be convex toward the active matrix substrate 4 merely differ in the above aspects, and it will be appreciated that the invention according to Embodiments 1 to 6 is applicable.

Portions similar to those of Embodiment 1 are denoted by like numerals, with their detailed description omitted.

The present application is based on Japanese Patent Application No. 2018-146954, filed on Aug. 3, 2018, the entire disclosure of which is incorporated herein by reference.

What is claimed is:

1. A display panel having a display region including a plurality of pixels arrayed along a first direction and along a second direction which is different from the first direction,
the display panel comprising a first substrate and a second substrate opposing each other, the first substrate and the second substrate being curved along the first direction, wherein,
the display region includes a central portion including a center of the display region along the first direction and, on both sides of the central portion along the first direction, two end portions that are located adjacent to the central portion;
the first substrate includes a plurality of pixel electrodes provided respectively corresponding to the plurality of pixels;
the second substrate has a color filter layer that includes: a plurality of color filters provided respectively corresponding to the plurality of pixels; and a black matrix;
among the plurality of color filters, each of a plurality of central color filters contained in the central portion includes a chromatic portion presenting a chromatic color; and,
among the plurality of color filters, a plurality of end color filters contained in the two end portions include an end color filter that includes a chromatic portion and a white portion presenting white, the white portion being disposed adjacent to the chromatic portion along the first direction.

2. The display panel of claim 1, wherein the plurality of central color filters include a central color filter that further includes the white portion, the white portion being disposed adjacent to the chromatic portion along the first direction.

3. The display panel of claim 1, wherein the plurality of end color filters include an end color filter whose chromatic portion presents a color that is R (0.64 to 0.67, 0.32 to 0.34), G (0.21 to 0.30, 0.60 to 0.71), or B (0.13 to 0.15, 0.05 to 0.06) in xy color coordinates.

4. The display panel of claim 1, wherein the plurality of central color filters include a central color filter whose chromatic portion presents a color of a saturation that is lower than a saturation of a color presented by the chromatic portion of one of the plurality of end color filters.

5. The display panel of claim 1, wherein,
the plurality of end color filters include a first end color filter and a second end color filter that include the white portions, the second end color filter being farther away, along the first direction, from the center of the display region along the first direction than is the first end color filter; and
a length of the white portion of the second end color filter along the first direction is greater than a length of the white portion of the first end color filter along the first direction.

6. The display panel of claim 1, wherein,
the plurality of end color filters include a first end color filter and a second end color filter, the second end color filter being farther away, along the first direction, from the center of the display region along the first direction than is the first end color filter; and
a saturation of a color presented by the chromatic portion of the second end color filter is higher than a saturation of a color presented by the chromatic portion of the first end color filter.

7. The display panel of claim 6, wherein the first end color filter and the second end color filter include the white portions, and a length of the white portion of the second end color filter along the first direction is greater than a length of the white portion of the first end color filter along the first direction.
